(19) United States
(12) Patent Application Publication
(10) Pub. No.: US 2012/0115060 A1
(43) Pub. Date: May 10, 2012

(54) PROPORTIONAL VALVE HAVING AN IMPROVED SEALING SEAT

(76) Inventors: Hubert STIER, Vaihingen/Enz (DE); Christian Will, Duisburg (DE); Frank Ilgner, Stuttgart (DE)

(21) Appl. No.: 13/289,767

(22) Filed: Nov. 4, 2011

(30) Foreign Application Priority Data
Nov. 9, 2010 (DE) 102010043619.4
Jul. 13, 2011 (DE) 102011079045.4

(51) Int. Cl. H01M 8/04; F16K 27/00

(52) U.S. Cl. 429/444; 251/366

(57) ABSTRACT

A proportional valve for controlling a gaseous medium, in particular hydrogen, including a nozzle body which has at least one pass-through opening, a closing element which releases and closes the pass-through opening on a valve seat, and an elastic sealing element, which provides a seal on the valve seat, the closing element being articulated with the aid of an articulated support.

### CROSS REFERENCE

The present application claims the benefit under 35 U.S.C. §119 of German Patent Application No. DE 102010043619.4 filed on Nov. 9, 2010, which is expressly incorporated herein by reference in its entirety.

### FIELD OF THE INVENTION

The present invention relates to a proportional valve for controlling a gaseous medium, in particular hydrogen, and in particular for use in vehicles which have a fuel cell drive.

### BACKGROUND INFORMATION

In the automotive sector, not only liquid fuels but also gaseous fuels will play an increasing role in the future. Hydrogen gas flows must be controlled, in particular in vehicles which have a fuel cell drive. In this case, the gas flows are no longer controlled discontinuously as in the injection of liquid fuels, but instead proportional valves are preferably used, which adjust an opening cross section of the valve as a function of a desired driving power.

Due to the small molecule size of gaseous hydrogen, strict requirements must be met with regard to a tightness of the proportional valve. Even minimal tilting of a closing element may result in unwanted leakages. A gas valve for natural gas is described in German Patent Application No. DE 10 2005 056 212 A1, in which a special geometry is provided on a nozzle body to achieve a medium flow which has as few losses as possible. However, this valve is not designed as a proportional valve but rather as an injection timing valve, and it provides no indication of ways to improve a seal on the valve seat.

### SUMMARY

A proportional valve according to an example embodiment of the present invention for controlling a gaseous medium may have the advantage that an improved tightness on the valve seat is ensured. In particular, slight tilting of a closing element may be compensated. In accordance with the present invention, this may be achieved by the fact that the closing element is articulated with the aid of an articulated support. Compensating movements of the closing element may thus be carried out via the articulated support. This makes it possible for a sealing element to always rest planarly on a valve seat. In particular, an effective sealing of gaseous hydrogen, which has a very small molecule size, is made possible thereby. The valve is preferably used to supply hydrogen to a fuel cell.

The example proportional valve according to the present invention preferably includes a component which has a pin-shaped end, in particular a pin, and the articulated support is situated between the pin-shaped end and the closing element. This makes it possible to integrate the articulated support into a connection between the pin-shaped end and the closing element.

A particularly cost-effective approach is achieved by the fact that a clearance fit between a pin-shaped end and the closing element is provided between the two components as an articulated support. A clearance between the pin-shaped end and the closing element is preferably in a range of approximately 0.01 mm to 0.03 mm and is particularly preferably approximately 0.02 mm.

In particular, the articulated support is preferably a ball element, the pin-shaped end, in particular, having a spherical design.

To allow for a preferably compact configuration, the pin-shaped end is preferably situated in a recess in the closing element. This makes it possible, in particular, to reduce an axial length of the proportional valve.

According to an alternative embodiment of the present invention, the example proportional valve also has a pin which preferably has a two-part design, and the articulated support is situated between the two parts of the pin. According to another alternative embodiment of the present invention, an articulated support is preferably situated on an end of the pin located opposite the closing element. These articulated supports may preferably also be designed as ball joints.

Furthermore, the sealing element on the valve seat preferably has a sealing diameter at which a sealing action occurs, and a distance between the articulated support and the valve seat when the proportional valve is closed is such that a ratio of the sealing diameter to the distance is greater than 1. This ensures that the closing element is able to align itself on the valve seat with the aid of a sliding action, and no self-retention occurs.

The closing element is preferably articulated on an actuator and captively situated thereon. The actuator is preferably a magnet armature. This enables a particularly compact configuration to be implemented. In particular, the actuator preferably includes a holding device, a form-locked connection being provided between the holding device and the closing element. The holding device is preferably a holding bushing. This holding bushing preferably projects over a free end of the actuator and forms a receiving chamber for accommodating the closing element. The form-locked connection between the holding device and the closing element makes it possible, in particular, to transmit axial forces from the actuator to the closing element.

The articulated support is preferably provided as a clearance fit between the holding device and the closing element, the closing element having a distance from the holding device in the lifting direction when the closing element is closed. A clearance between the holding device and the closing element in the radial direction toward the center line is preferably between 0.05 mm and 0.09 mm. The clearance of the clearance fit is preferably selected in such a way that tilting movements as well as radial runout from the pass-through opening are limited. In particular, an extensive tilting movement when the valve is open should be avoided to prevent flow fluctuations resulting from movements of the closing element. The distance between the closing element and the holding device in the lifting direction is preferably at least 0.1 mm.

In particular, the sealing element provides a sealing action on a sealing diameter on a valve seat, the closing element having a height in an axial direction, i.e., a direction of movement, for opening and/or closing the proportional valve, and a ratio of the sealing diameter to the height of the sealing element being greater than 1. A ratio of greater than 1 between the sealing element and the height of the closing element ensures that the closing element is able to align itself by sliding on the valve seat, and no self-retention occurs.

Too great a radial runout would furthermore cause a reduction in an overlap between the valve seat and the closing element, which could result in impermissible leakage.

The form-locked connection between the holding device and the closing element is preferably achieved by providing radial contact surfaces which are radial to a direction of movement of the closing element. The radial contact surfaces are preferably annular, circumferential areas on the closing element and the holding device.

According to a further preferred embodiment of the present invention, the proportional valve furthermore has a stop which delimits a tilting movement of the closing element. Excessive tilting movements are thereby avoided, in particular when the proportional valve is open, which could result in flow fluctuations during operation due to a movement of the closing element. Since the proportional valve is open in nearly all operating positions during operation of a fuel cell, the articulated support should preferably allow a maximum clearance of 0.03 mm.

The present invention furthermore relates to a fuel cell system having a fuel cell and having a proportional valve according to the present invention for controlling gaseous hydrogen.

### BRIEF DESCRIPTION OF THE DRAWINGS

Preferred exemplary embodiments of the present invention are described in detail below with reference to the figures.

FIG. 1 shows a schematic sectional view of a proportional valve according to an exemplary embodiment of the present invention.

FIG. 2 shows an enlarged representation of the proportional valve from FIG. 1.

FIG. 3 shows an enlarged sectional representation of a nozzle body of the proportional valve according to a second exemplary embodiment of the present invention.

FIG. 4 shows an enlarged sectional representation of a nozzle body of the proportional valve according to a third exemplary embodiment of the present invention.

FIG. 5 shows an enlarged sectional representation of a nozzle body of the proportional valve according to a fourth exemplary embodiment of the present invention.

### DETAILED DESCRIPTION OF EXAMPLE EMBODIMENTS

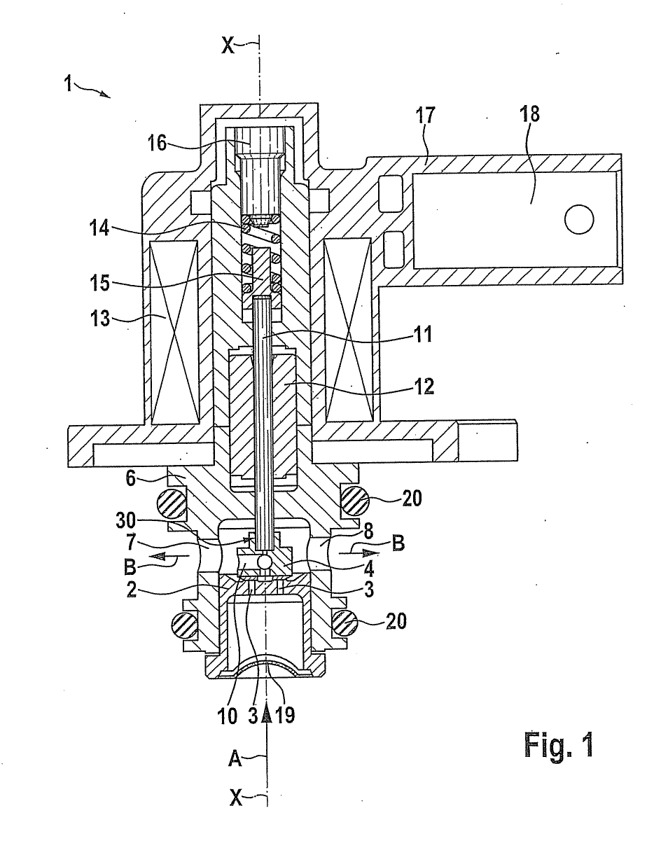

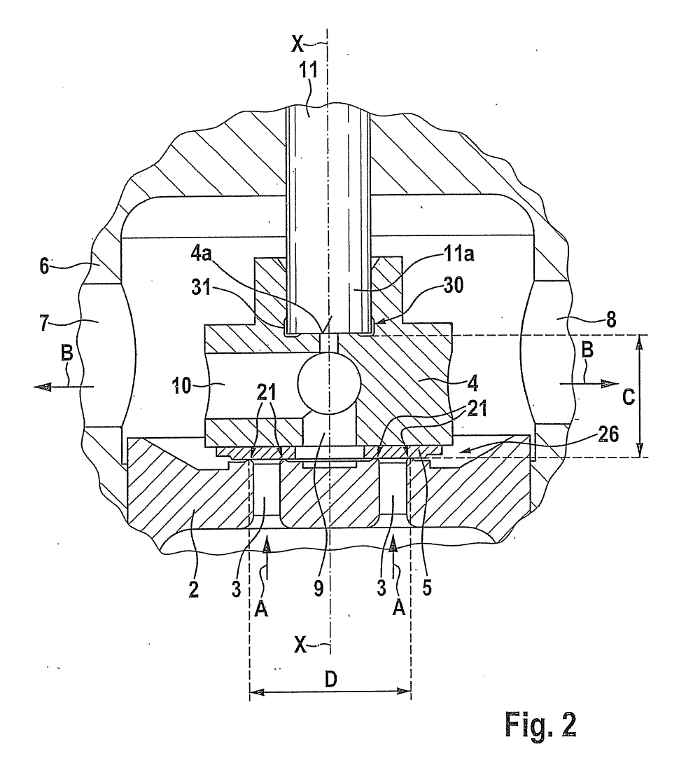

A proportional valve 1 for controlling a gaseous medium is described in detail below with reference to FIGS. 1 and 2. Proportional valve 1 illustrated in the figures is used to control gaseous hydrogen which is supplied, for example, to a fuel cell in a vehicle.

As is shown in FIG. 1, proportional valve 1 includes a valve housing 6 which has a magnet armature 12, a solenoid coil 13 and a pin 11 which is connected to magnet armature 12. A closing spring 14 is connected to pin 11 via a spring holder 15. Reference numeral 16 identifies an adjusting bolt for adjusting a restoring force of closing spring 14. Solenoid coil 13 is fixed in a plastic overmold 17 on valve housing 6. A plug connector 18 is provided on the side of proportional valve 1. A closing element 4 is situated on pin-shaped end 11a of pin 11, which is located opposite closing spring 14. Closing element 4 closes pass-through openings 3 which are provided in a nozzle body 2. Pass-through openings 3 are situated around a center line X-X of proportional valve 1 in the shape of a kidney. Three pass-through openings 3 are preferably provided, but also only two or four or five pass-through openings may be provided. Webs are provided between each of the individual pass-through openings in the circumferential direction.

As is also shown in FIG. 1, a filter 19, through which an inflow of the gaseous medium (arrow A) occurs, is provided on nozzle body 2. O-rings 20 are provided for sealing the proportional valve in a component. A discharge of the gaseous medium takes place in the radial direction (arrows B).

As is shown, in particular, from FIG. 2, a vertical discharge bore 9 and multiple horizontal discharge bores 10 are provided in closing element 4. Three horizontal discharge bores 10 are provided in this exemplary embodiment. Moreover, an annular, elastic sealing element 5 is situated on closing element 4. Annular sealing element 5 seals pass-through openings 3 on a valve seat 21. Valve seat 21 runs around the outer circumference of pass-through openings 3. As is apparent from FIG. 2, orifices of pass-through openings 3 are provided in an indentation 26 in nozzle body 2.

Additional outflow bores 7, 8, which run in the radial direction, are situated in valve housing 6. When the valve opens, closing element 4, along with sealing element 5, lifts off valve seat 21 on nozzle body 2 and releases an opening cross section according to the lift of closing element 4. Since a flow path in closing element 4 is also provided via discharge bores 9, 10 in this exemplary embodiment, gas flows both through closing element 4 and directly along the side of closing element 4 into outflow bores 7, 8. This allows a large amount of gas to flow out at closing element 4 using relatively little lift.

As is shown in FIG. 2, which represents the closed state of proportional valve 1, sealing element 5 is provided in such a way that the sealing element rests planarly on valve seats 21 at pass-through openings 3. According to the present invention, an articulated support 30 is provided for this purpose between pin 11 and closing element 4. As is shown in FIG. 2, a clearance fit 31 is provided as articulated support 30. An end 11a of pin 11 is inserted into a recess 4a in closing element 4, and a clearance fit 31 is provided between end 11a of pin 11 and closing element 4. The clearance between end 11a and recess 4a is preferably 0.02 mm.

FIG. 2 also shows a sealing diameter D, on which sealing element 5 provides a sealing action on each radial outer valve seat 21 of nozzle body 2. A distance C is furthermore provided between articulated support 30 and valve seat 21 when the proportional valve is closed (see FIG. 2). Distance C and sealing diameter D are selected in such a way that a ratio of sealing diameter D to distance C is greater than 1 (D:X>1). This enables closing element 4 to align itself on nozzle body 2 by a sliding movement on valve seat 21.

According to the present invention, articulated support 30 may be used to ensure that any dimensional deviations on nozzle body 2 may be compensated by a tilting movement of closing element 4. Clearance fit 31 is selected in such a way that the tilting movement is delimited and an integrated stop is thus provided in clearance fit 31. Due to the relatively small clearance of 0.02 mm, a strong tilting movement may thus be avoided when the proportional valve is open, which enables flow fluctuations resulting from excessive movements of closing element 4 to be avoided. As a result, the accuracy of the metering of hydrogen through the proportional valve according to the present invention, having an articulated closing element support, is provided.

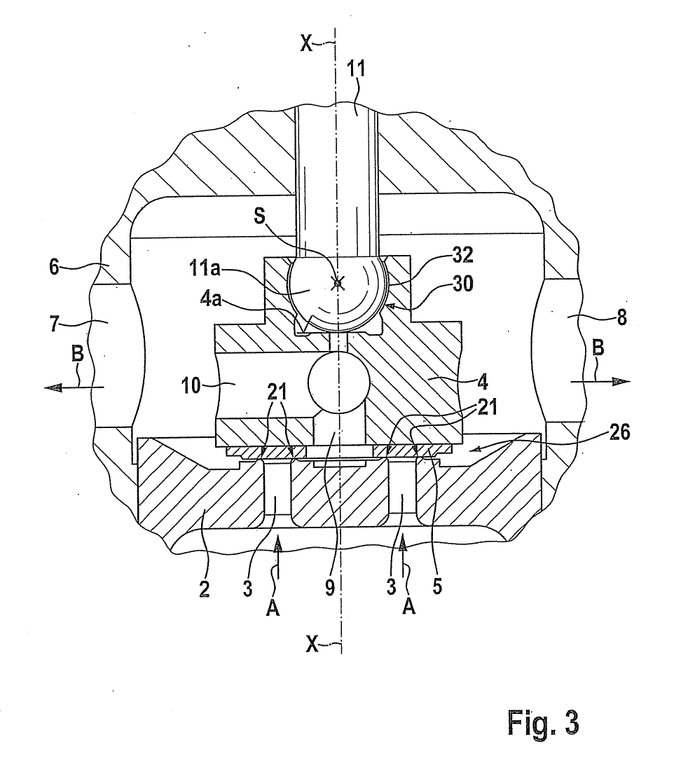

FIG. 3 shows a proportional valve 1 according to a second exemplary embodiment of the present invention, identical or functionally identical parts being identified by the same reference numerals as in the first exemplary embodiment. In contrast to the first exemplary embodiment, the proportional valve in the second exemplary embodiment has a ball joint 32 as articulated support 30. For this purpose, a ball which is accommodated in a correspondingly formed receptacle in recess 4a is provided at end 11a of pin 11. This enables closing element 4 to pivot around a pivot point S, which is the central point of the ball at end 11a of the pin. In other respects, this exemplary embodiment corresponds to the preceding exemplary embodiment, so that reference may be made to the description provided therein.

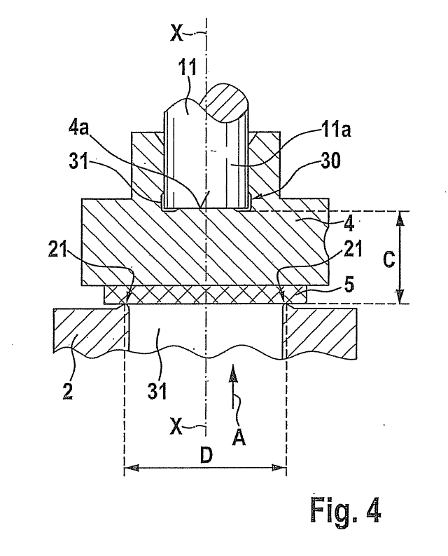

A proportional valve according to a third exemplary embodiment of the present invention is described in detail below with reference to FIG. 4. Identical or functionally identical parts are identified by the same reference numerals as in the first and second exemplary embodiments.

In contrast to the first exemplary embodiment, the proportional valve in the third exemplary embodiment does not have any kidney-shaped pass-through openings but instead has one central pass-through opening 31. FIG. 4 again shows the closed state of the proportional valve, in which sealing element 5 rests on annular valve seat 21 and provides a seal.

In addition, in contrast to the first exemplary embodiment, no discharge bores are provided in closing element 4 in the second exemplary embodiment. In the second exemplary embodiment, these discharge bores are not necessary since the relatively large diameter of central pass-through opening 31 permits a sufficient media flow. The third exemplary embodiment has, in particular, simplified components, making it possible to reduce the manufacturing costs of a proportional valve of this type. Alternatively, valve seat 21 may also be situated on the closing element, and the sealing element may be situated around pass-through opening 31 on nozzle body 2. In other respects, this exemplary embodiment corresponds to the first exemplary embodiment, so that reference may be made to the description provided therein.

Furthermore, it should be noted that the third exemplary embodiment may also be equipped with a ball joint as the articulated support, according to the second exemplary embodiment.

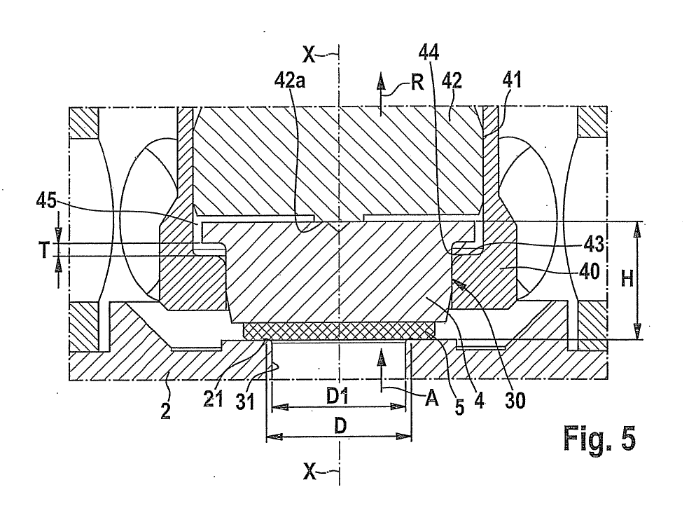

FIG. 5 shows a proportional valve 1 according to a fourth exemplary embodiment of the present invention, identical or functionally identical parts being identified by the same reference numerals as in the preceding exemplary embodiment.

Proportional valve 1 in the fourth exemplary embodiment includes an actuator 42, in particular a magnetic actuator, as well as a cylindrical holding bushing 40. Holding bushing 40 is attached to actuator 42 with the aid of a press fit 41.

Holding bushing 40 furthermore has an annular, radial stop surface 43. The stop surface is designed as an annular collar. An annular, radial stop surface 44 is also provided on closing element 4. In this case, radial stop surface 43 on the holding bushing is oriented radially toward the inside, and stop surface 44 on closing element 4 is oriented radially toward the outside so that a form-locked connection is provided between holding bushing 40 and closing element 4. Closing element 4 is thus situated in such a way that it is positioned loosely in chamber 45 which is formed by holding bushing 40 at the end of actuator 42. This makes it possible to transmit an axial force to closing element 4 for the purpose of opening the proportional valve.

FIG. 5 shows the completely closed state of the proportional valve. When the proportional valve is to be opened, actuator 42 moves in the direction of arrow R. Closing element 4 is not yet carried along by radial stop surface 43 on holding bushing 40 but instead is located loosely in a retaining chamber 45. However, sealing element 5 is lifted off valve seat 21 due to the pressure present at central pass-through opening 31. When distance T, present in the closed state of the proportional valve, is overridden by the lift of actuator 42, the form-locked connection in the form of stop surfaces 43, 44 carries along closing element 4 and lifts it completely off valve seat 21. For closing purposes, a force is applied counter to the opening force, so that an end surface 42a of actuator 42 presses against closing element 4. This makes it possible to transfer an axial force to closing element 4. During the closing action, closing element 4 may be aligned on articulated support 30 between closing element 4 and holding bushing 40. To prevent self-retention of closing element 4 in holding bushing 40, a ratio of a sealing diameter D to a height H, which closing element 4 has in axial direction X-X, is greater than 1. This ensures that closing element 4 is able to align itself by sliding on valve seat 21, and a secure seal is always achieved thereby, even in the event of a slightly tilted actuator 42. The sealing action takes place at sealing diameter D, which is slightly larger than a diameter D1 of central pass-through opening 31.

The described exemplary embodiments thus show a proportional valve 1 for controlling a hydrogen gas flow, the proportional valve being used, in particular, for supplying gas to fuel cells. Due to the articulated support of closing element 4, closing element 4 may execute a compensating movement if dimensional deviations have occurred on the components, for example, due to manufacturing-specific tolerances. Nevertheless, a secure seal is always achieved, due to the articulated support of closing element 4.

Proportional valve 1 according to the present invention is thus provided for controlling a hydrogen gas flow, the proportional valve being used, in particular, for supplying gas to fuel cells. The embodiment according to the present invention permits a secure seal and a very accurate metering of hydrogen, since, in particular, imprecise opening and closing, due to sealing element 5 adhering to valve seat 21, may be avoided.

What is claimed is:

1. A proportional valve for controlling a gaseous medium, comprising:
a nozzle body which has at least one pass-through opening;
a closing element which releases and closes the pass-through opening on a valve seat; and
an elastic sealing element which provides a seal on the valve seat;
wherein the closing element is articulated with the aid of an articulated support.

2. The proportional valve as recited in claim 1, wherein the gaseous medium is hydrogen.

3. The proportional valve as recited in claim 1, wherein the articulated support is situated between a pin-shaped end and the closing element.

4. The proportional valve as recited in claim 3, wherein a clearance fit is provided between the pin-shaped end and the closing element as the articulated support.

5. The proportional valve as recited in claim 3, wherein the articulated support is a ball joint which is situated between the pin-shaped end and the closing element.

6. The proportional valve as recited in claim 3, wherein the pin-shaped end is situated in a recess in the closing element.

7. The proportional valve as recited in claim 1, further comprising:
a pin which has a two-part design, one of the articulated support being situated between the two parts of the pin, or the articulated support being situated on an end of the pin which is located opposite the closing element.

8. The proportional valve as recited in claim 1, wherein the sealing element on the valve seat provides a seal on a sealing diameter, and a distance between the articulated support and the valve seat when the proportional valve is closed is such that a ratio of the sealing diameter to the distance is greater than 1.

9. The proportional valve as recited in claim 1, wherein the closing element is captively situated on an actuator.

10. The proportional valve as recited in claim 9, wherein the actuator includes a holding device, a form-locked connection being provided between the holding device and the closing element.

11. The proportional valve as recited in claim 10, wherein the holding device is a holding bushing.

12. The proportional valve as recited in claim 10, wherein the articulated support is a clearance fit between the holding device and the closing element, the closing element in the closed state having a distance from the holding device in the lifting direction.

13. The proportional valve as recited in claim 9, wherein the sealing element on the valve seat provides a seal on a sealing diameter and the closing element has a height in an axial direction of the proportional valve, a ratio of the sealing diameter to the height being greater than 1.

14. The proportional valve as recited in claim 10, wherein the holding device and the closing element have radial stop surfaces as the form-locked connection, the stop surfaces having an annular design.

15. The proportional valve as recited in claim 1, further comprising:
a stop which delimits a compensating movement of the closing element.

16. A fuel cell system, including a proportional valve for controlling a hydrogen supply to a fuel cell, the proportional valve comprising:
a nozzle body which has at least one pass-through opening;
a closing element which releases and closes the pass-through opening on a valve seat; and
an elastic sealing element which provides a seal on the valve seat;
wherein the closing element is articulated with the aid of an articulated support.
